(19) United States
(12) Patent Application Publication
(10) Pub. No.: US 2005/0103949 A1
(43) Pub. Date: May 19, 2005

(54) Intravenous line holder

(76) Inventors: Kellie Ross, Bristow, VA (US); Arthur A. Krause, Winnetka, CA (US)

Correspondence Address: Dennis H. Lambert & Associates, 7000 View Park Drive, Burke, VA, 22015, US

(21) Appl. No.: 10/715,223

(22) Filed: Nov. 17, 2003

(51) Int. Cl. F16L 3/22

(52) U.S. Cl. 248/68.1

(57) ABSTRACT

An intravenous line holder for holding, separating and organizing a plurality of intravenous lines is made from a thin, flat piece of material having a planar central portion and opposite marginal edge portions. At least one of the marginal edge portions has a plurality of openings formed through it for receiving lengths of IV line, and slits extend through the edge of the holder to the openings for enabling the IV lines to be inserted through the slits and into the openings. In a preferred embodiment, the holder is made from paperboard and has aligned openings formed through two opposed marginal edge portions. The marginal edge portions are joined to the central portion about respective fold lines, so that they may be folded downwardly to form two opposed wings. Suitable indicia may be placed on the central portion to identify the use or purpose of the respective IV lines.

### TECHNICAL FIELD

This invention relates to medical devices, and more particularly, to a device for keeping multiple intravenous lines organized and separate from one another.

### BACKGROUND ART

The treatment of a patient often requires the simultaneous administration of several intravenous solutions, and/or the use of intravenous catheters and monitoring devices for such measurements as central venous pressure, pulmonary artery and pulmonary wedge pressures, and the like. This is especially true in operating room environments and acute care settings, such as adult, pediatric and neonatal intensive care units.

Intravenous lines typically extend from a source of medication suspended from an IV pole to an injection site on the patient, or from a catheter associated with the patient to measuring or monitoring equipment. In order to accommodate movement of the patient, and to place the medication and/or monitoring equipment out of the way, the individual lengths of IV line can be quite long.

It is critically important that each length of IV line is connected between a respective injection site and the appropriate medication or monitoring device. As the number and length of the IV lines being used increase, this task becomes more difficult and time consuming, especially when it is considered that the lines are clear and the solutions that run through them are primarily clear. It is up to the nurse to ensure that each individual line is properly identified and connected. The skills of a registered nurse in an acute setting are of paramount importance in the quality of patient care, and the time required for the nurse to carefully inspect and ensure that each line is properly connected adds to the cost of medical care. More importantly, an improperly connected IV line can have serious consequences on the health of the patient, and can even lead to the patient's death.

At the present time, nurses generally have no option but to label lines with silk tape in an attempt to identify each line. While this may appear to be a solution to the problem of tangled lines and intravenous line identification, the tape often becomes soiled, making it difficult to read, or the tape may come loose from the line, or more importantly, does nothing to prevent the lines from becoming tangled. In an emergency situation, the nurse needs to rapidly identify each line in order to medicate the patient with the appropriate drugs. If the nurse mistakenly injects a drug into the wrong line, the consequences can be lethal to the patient.

With hospitals and other medical care facilities having to increasingly cope with a nursing shortage and with budget constraints, while at the same time ensuring patient safety, efforts to save time and money have become increasingly important. In a “typical” post-transplant patient, it takes two nurses nearly fifteen minutes to untangle the lines on a patient coming from the surgery suite. In addition to the cost associated with this task, the nurses' time could be better spent doing patient assessment, intervention, or evaluation of treatments.

Further, hospitals are required to keep IV line as clean as possible, not allowing it to touch the floor in an effort to prevent nosocomial infections. Frequently, IV line is coiled then taped to prevent it from touching the floor. However, when a patient needs to be transported or repositioned, the tape is difficult to remove and inevitably the lines again become tangled.

Also, IV lines are sometimes taped to the patient's skin to help keep the lines separated and organized. Patients in trauma intensive care units frequently have multiple open wounds on them, requiring dressing changes and additional care. Applying tape to the skin may not be a viable option in these cases.

In order to alleviate these problems and concerns, various devices have been developed in the prior art. Exemplary of such devices are those disclosed in U.S. Pat. Nos. 4,308,642, 4,795,429, 4,988,062, 5,224,674, 5,226,892, 5,389,082, 5,795,335, and Des 263,624. While the devices disclosed in these patents do function as IV line organizers, they are relatively complicated and expensive. Under present day circumstances, it is important to have an IV line organizer that is easy to use and that is inexpensive.

Accordingly, there is need for an inexpensive IV line organizer that is simple in construction and easy to use.

### DISCLOSURE OF THE INVENTION

The present invention comprises an inexpensive IV line holder and separator that is simple in construction and easy to use. More specifically, the IV line holder of the invention is a thin, flat sheet of material, with at least one marginal edge portion that is bendable to an angled position to define a wing. Openings are formed through the wing for receiving and holding lengths of IV line in separated, parallel relationship. Cuts or slits lead from the edges of the margin portions to the openings, and the lines can be inserted through these cuts or slits into the openings. In essence, the lines are “snapped” into place. The anterior or upper surface of the central portion of the holder, between the margin portions, provides a planar surface on which suitable indicia may be placed to identify the purpose of the line held beneath that portion of the holder, or the material flowing through that line.

In a preferred embodiment, opposite marginal edge portions are bendable to define a pair of opposed wings having aligned openings for receiving IV lines.

Further, in the preferred embodiment the holder is made of a thin, unitary sheet of paperboard that is rectangular or square in shape, scored along opposite sides to define the opposed bendable wings or margins, and that may be die cut to form the slits and openings in the wings. The center portion of the sheet, between the bendable wings, may be printed with suitable indicia, and/or may be marked with suitable indicia to identify the separate lines held thereby. For example, color coded labels can be applied to the anterior surface of the central portion of the holder. Three-channel pumps with color-coded channels for line identification are currently available in intensive care settings. The color-coding on the holder of the invention can match the color-coding on these pumps.

In use, a nurse simply presses a line through the slits into each opening in the wing or wings, so that the lines are held in separated, parallel relationship. In the preferred embodiment, the lines extend beneath the central portion of the holder and through a pair of aligned openings in wings at opposite sides of the holder. As many lines as desired may be engaged with the holder, up to the maximum number of lines the holder will accommodate. In this regard, the holder can be designed to hold any desired number of lines, although three to six pairs of aligned openings, for holding three to six lines, typically would be provided in the holder. If more lines are required, multiple holders can be used. If desired, the holder can be attached to a surface to support it and the attached lines in a particular location. Any suitable means can be used to attach the holder to a surface, such as a clip, or Velcro fasteners, or an adhesive backing on the holder, etc.

The slits leading into the openings can have various configurations to more securely retain the lines in the openings and at the same time enable easy insertion of the lines through the slits into the openings. For instance, the slits can have offset portions, or can enter the opening out of alignment with the position of the line when it is in place, thereby resisting inadvertent retraction of the line through the slit during use.

The IV line holder of the invention may be made of any suitable material, although in a preferred embodiment it is made from a paperboard material suitably treated in accordance with commercially available materials and processes to render it suitable for use in a medical environment.

### BRIEF DESCRIPTION OF THE DRAWINGS

The foregoing as well as other objects and advantages of the invention will be apparent in the following detailed description when considered in conjunction with the accompanying drawings, wherein like reference characters refer to like parts throughout the several views, and wherein:

FIG. 1 is a top perspective view of an IV line holder and holder according to the invention.

FIG. 2 is a side view in elevation of the line holder of FIG. 1.

FIG. 3 is a side view in elevation of the line holder, with the bendable wings at opposite sides folded downwardly to receive lengths of IV line, shown in broken lines.

FIG. 4 is a top plan view of the IV line holder of the invention, showing a plurality of IV lines in broken lines.

FIGS. 5-8 are top plan views of the IV holder, showing alternate shapes to the slits extending between the outer edges of the wings to the openings.

FIG. 9 is a top plan view of an alternate embodiment of the IV line holder, wherein a bendable wing is provided at only one side of the holder.

### BEST MODE FOR CARRYING OUT THE INVENTION

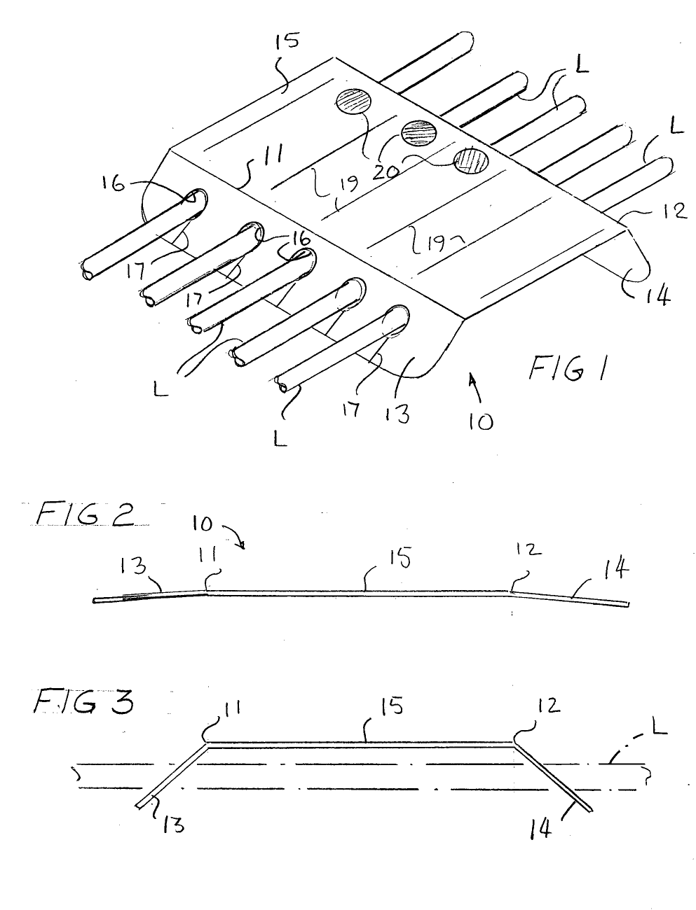

With particular reference to FIGS. 1-4, the IV line holder of the invention is indicated generally at 10, and comprises a thin, unitary, rectangular or square sheet of paperboard having sufficient thickness and stiffness only to generally retain it shape and hold the lines attached thereto. A pair of spaced, parallel scores 11 and 12 are formed along opposite sides of the sheet, forming two bendable wings 13 and 14 at opposite sides of a planar central portion 15. A plurality of openings 16 are formed in the wings, with the openings in opposite wings defining aligned pairs of openings. As depicted in FIG. 1, the openings may be made larger than the lines for loosely receiving the lines. Slits or cuts 17 are formed in the edges of the wings, extending from the respective openings through the edge. As shown in FIG. 1, the slits extend through the edge of the wings in line with the lines L held in the respective openings.

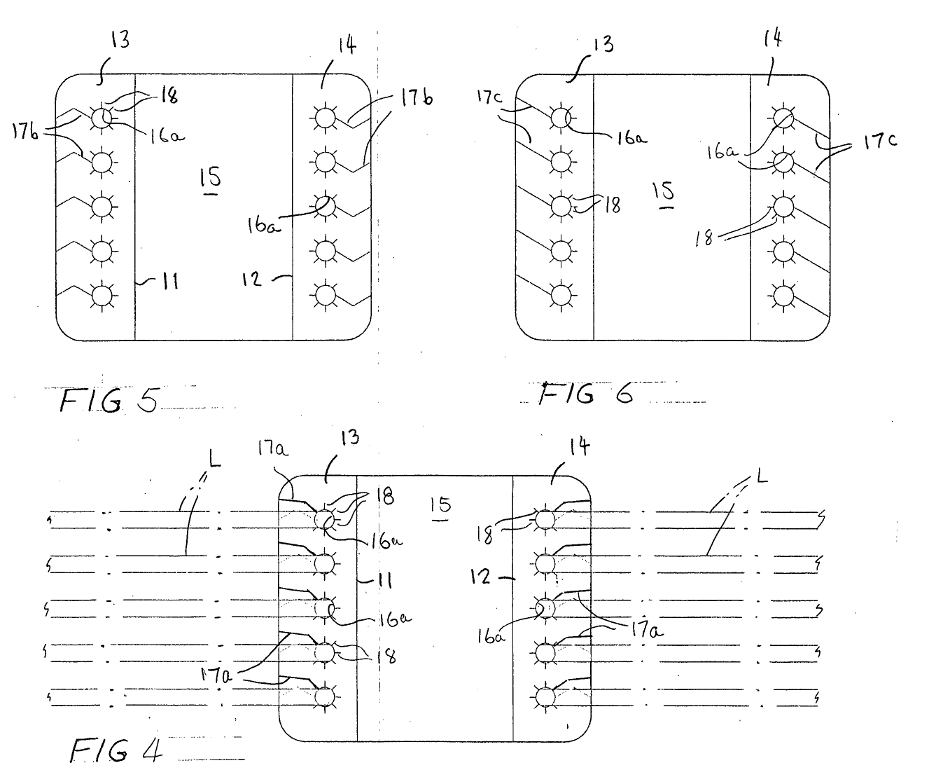

If desired, as seen in FIG. 4, for instance, short radially extending cuts 18 may be made around the edges of the openings 16a to lend some flexibility to the edges of the openings for snugly receiving the lines without crushing or deforming the lines. Further, as shown in this figure the slits 17a enter the opening at an angle and out of alignment with the axis of the lines. This helps prevent the lines from being inadvertently displaced back through the openings during use of the holder.

As shown in FIG. 1, lines 19 may be pre-printed on the top or anterior surface of the holder 10, dividing the anterior surface into areas corresponding to locations of lines extending beneath the central portion of the holder. The nurse or other medical personnel may then use a suitable implement to place identifying indicia on the holder to clearly label and identify the purpose of the line held at that location. Color-coded indicia 20 may be placed on the anterior surface, if desired, also as shown in FIG. 1.

As depicted in FIG. 5, the slits 17b have a chevron shape, and in FIG. 6 the slits 17c extend diagonally to the openings, out of alignment with lines placed in the openings. Both of these variations help retain the lines in the openings.

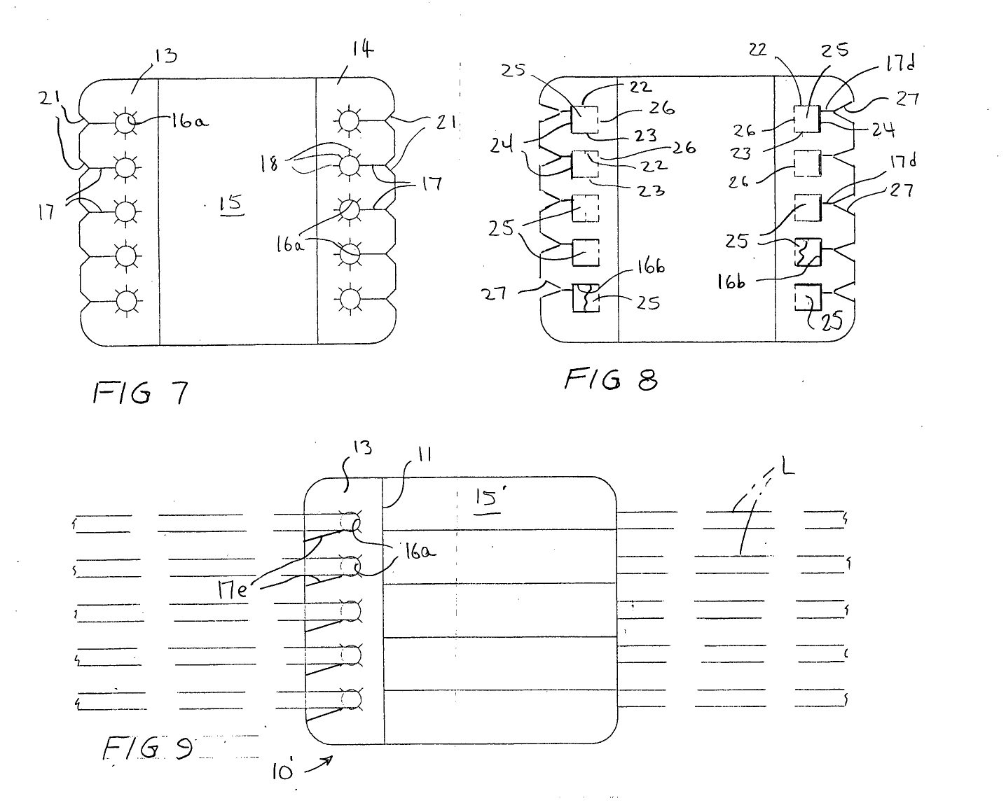

FIG. 7 depicts a further variation, wherein notches 21 are formed in the outer edges of the wings, in alignment with the slits 17. This arrangement guides the lines into the ends of the slits during attachment of the lines to the holder.

A still further variation is shown in FIG. 8, wherein two cuts 22 and 23 are made orthogonally to a third cut 24 in the wings 13 and 14, defining small flaps 25 that are foldable about fold line 26 extending between the ends of cuts 22 and 23, and defining openings 16b that are rectilinear in shape. Slits 17d extend from the edge of the respective wings to the openings, in offset relationship to the centerline of the openings, and notches 27 are formed in the outer edges of the wings at the ends of the slits.

An alternate embodiment of the invention is shown in FIG. 9, wherein a bendable wing 13 is provided on only one side of the planar portion 15′ of the holder 10′, and the slits 17e extend in a straight line at an angle from an offset position on the edge of the openings 16a.

The invention provides a simple and inexpensive means for holding IV lines and keeping them separated and organized, with provision for easy labeling of the lines to identify the purpose or use of each line.

While particular embodiments of the invention have been illustrated and described in detail herein, it should be understood that various changes and modifications may be made to the invention without departing from the spirit and intent of the invention as defined by the scope of the appended claims.

1. An intravenous line holder for keeping multiple intravenous lines separated and organized and providing visual recognition of proper placement of the intravenous lines, comprising:
a thin, flat sheet of material having a first, substantially flat, planar, anterior or upper surface portion, and a marginal edge portion with an outer end edge;
a plurality of side-by-side openings formed through said marginal edge portion in spaced relation to said outer end edge; and
a normally closed slit extending from each opening through said outer end edge of said marginal edge portion, said holder being made of a material having sufficient flexibility to enable lengths of intravenous lines to be pressed through respective slits and into respective openings, whereby a plurality of separate intravenous lines can be engaged in respective openings to hold the intravenous lines in separated, organized relationship to provide visual recognition of proper connection of the respective lines and thus help prevent erroneous connection thereof.

2. An intravenous line holder as claimed in claim 1, wherein:
said first, substantially flat, planar anterior or upper surface portion is adapted to receive indicia thereon adjacent each separate intravenous line to identify the use or purpose of each line held by the holder.

3. An intravenous line holder as claimed in claim 2, wherein:
said marginal edge portion is foldably joined to the central portion at a fold line, defining a first foldable wing through which the openings are formed.

4. An intravenous line holder as claimed in claim 3, wherein:
said first portion comprises a central portion, and there is a marginal edge portion on each of opposite side edges of said central portion, said marginal edge portions being bendable at an angle to the central portion to define a pair of spaced apart opposed wings having said openings therein for receiving IV lines, the openings in opposed wings being in aligned relationship with one another.

5. An intravenous line holder as claimed in claim 1, wherein:
the holder is made from paperboard.

6. An intravenous line holder as claimed in claim 2, wherein:
the holder is made from paperboard.

7. An intravenous line holder as claimed in claim 3, wherein:
the holder is made from paperboard.

8. An intravenous line holder as claimed in claim 4, wherein:
the holder is made from paperboard.

9. An intravenous line holder as claimed in claim 1, wherein:
the slits are shaped to resist removal of the intravenous lines from the openings.

10. An intravenous line holder as claimed in claim 9, wherein:
the slits include angularly offset portions.

11. An intravenous line holder as claimed in claim 10, wherein:
the slits connect with the respective openings at a point offset from alignment with a length of IV tubing held in the associated opening.

12. An intravenous line holder as claimed in claim 1, wherein:
the outer end edges of the holder are notched where the slit extends through the outer end edge, to guide an intravenous line into the slit.

13. An intravenous line holder as claimed in claim 1, wherein:
the openings have a size to snugly engage the length of IV line received in the opening.

14. An intravenous line holder as claimed in claim 13, wherein:
a series of radially extending short cuts are made around the edges of the openings to impart some flexibility to the material around the opening and prevent crushing or deformation of the IV line held in the opening.

15. An intravenous line holder as claimed in claim 8, wherein:
the paperboard material is treated to make it suitable for use in a medical environment.

16. An intravenous line holder as claimed in claim 4, wherein:
said wings are folded downwardly, whereby said intravenous lines pass beneath said central portion when said holder is in use, and said indicia is placed on said flat, planar, upper surface above respective intravenous lines held in said holder.
